(19) United States
(12) Patent Application Publication
(10) Pub. No.: US 2024/0359413 A1
(43) Pub. Date: Oct. 31, 2024

(54) SYSTEMS AND METHODS FOR COMPOSITE STRINGER PACKAGE CONSTRUCTION AND COMPACTED STRINGER PACKAGES

(71) Applicant: The Boeing Company, Arlington, VA (US)

(72) Inventors: Clay R. Parrish, Charleston, SC (US); Luis F. Velasquez, Ladson, SC (US); Richard E. Heath, Mount Pleasant, SC (US)

(73) Assignee: The Boeing Company, Arlington, VA (US)

(21) Appl. No.: 18/307,104

(22) Filed: Apr. 26, 2023

(51) Int. Cl. B29C 70/44

(52) U.S. Cl. CPC B29C 70/443; B29C 70/446; B29L 2031/3082; B29L 2031/3085

(57) ABSTRACT

A system for constructing a compacted stringer package includes a compression housing that includes a tray and a lid that is movable relative to the tray such that the compression housing is in an open state or in a closed state. The system includes a compression layer that is positioned over the tray. The system includes a breather layer that is positioned over the compression layer. With the compression housing in the closed state, the lid and the compression layer form a sealed chamber. With the compression housing in the closed state, the breather layer is positioned between the lid and the compression layer and within the sealed chamber. With the compression housing in the closed state, the breather layer distributes vacuum within the sealed chamber.

### FIELD

The present disclosure relates generally to composite manufacturing and, more particularly, to systems and methods for constructing composite stringer packages and composite manufacturing with compacted composite stringer packages.

### BACKGROUND

Aircraft generally include an airframe, which may be regarded as an underlying skeleton to which skins are attached to form a smooth aerodynamic outer surface. Stringers of various shapes may be used for stiffening fuselage sections and wing skins on aircraft. Composite materials are often used in aircraft to decrease the weight of the aircraft. Modern aircraft may include both composite stringers and composite skins. Conventionally, composite stringers are attached to a composite skin using fasteners, curing the composite stringers to the composite skin, or a combination of the two. In some conventional processes, composite stringers are assembled on a cure tool common to both the composite stringers and the composite skin.

Conventional composite stringer manufacturing requires separate processing and installation of all components that form the composite stringer. The process is time and labor intensive and is required for each stringer. Initially, plies of composite material that form the stringer are installed on a cure tool. The plies of composite material are then compacted on the cure tool in an initial compaction step. Subsequently, a bladder and/or radius fillers are then individually installed, as needed, on the cure tool to complete a stringer package. This stringer package is then compacted on the mandrel in a subsequent compaction step. A composite preform that forms the composite skin is then installed on the cure tool. The entire composite structure is then compacted again in a final compaction step.

Each process associated with constructing the composite stringers adds to overall manufacturing time. Manufacturing time may limit the quantity of aircraft produced. Accordingly, those skilled in the art continue with research and development efforts in the field of composite manufacturing.

### SUMMARY

Disclosed are examples of a system for constructing a compacted stringer package, a composite manufacturing method, a method for constructing a compacted stringer package, and a compacted stringer package. The following is a non-exhaustive list of examples, which may or may not be claimed, of the subject matter according to the present disclosure.

In an example, the disclosed system for constructing a compacted stringer package includes a compression housing that includes a tray and a lid that is movable relative to the tray such that the compression housing is in an open state or in a closed state. The system includes a compression layer that is positioned over the tray. The system includes a breather layer that is positioned over the compression layer. With the compression housing in the closed state, the lid and the compression layer form a sealed chamber. With the compression housing in the closed state, the breather layer is positioned between the lid and the compression layer and within the sealed chamber. With the compression housing in the closed state, the breather layer distributes vacuum within the sealed chamber.

In an example, the disclosed composite manufacturing method includes steps of: (1) arranging a composite charge, a bladder, and at least one radius filler within a compression housing to form a composite stringer package; and (2) compacting the composite stringer package within the compression housing to form a compacted stringer package.

In an example, the disclosed method for constructing a compacted stringer package includes steps of: (1) arranging a composite charge, a bladder, and at least one radius filler on a tray of a compression housing to form a composite stringer package; (2) applying vacuum to a sealed chamber formed by a compression layer and a lid of the compression housing; and (3) compacting, by applying vacuum, the composite stringer package between the compression layer and the lid to form the compacted stringer package.

In an example, the disclosed compacted stringer package includes a composite charge that is placed over a portion of a bladder and positioned on a tray of a compression housing. The compacted stringer package includes a first radius filler that is positioned in contact with the composite charge and the bladder. The compacted stringer package includes a second radius filler that is positioned in contact with the composite charge and the bladder and aligned with the first radius filler. The composite charge, the bladder, the first radius filler, and the second radius filler are enclosed within a sealed chamber that is formed by a lid of the compression housing and a compression layer that is positioned between the composite charge and the tray. The composite charge, the bladder, the first radius filler, and the second radius filler are compacted between the compression layer and the lid by vacuum applied within the sealed chamber.

Other examples of the system, the methods, and the stringer package disclosed herein will become apparent from the following detailed description, the accompanying drawings, and the appended claims.

### BRIEF DESCRIPTION OF THE DRAWINGS

FIG. 1 is schematic, exploded, sectional, end view of an example of a system for constructing a compacted stringer package;

FIG. 2 is schematic, exploded, sectional, end view of an example of the system and an example of a composite stringer package;

FIG. 3 is a schematic, sectional, end view of an example of the system, depicting an example of a compression housing in an open state and an example of the composite stringer package;

FIG. 4 is a schematic, sectional, end view of an example of the system, depicting an example of the compression housing in a closed state and an example of the composite stringer package;

FIG. 5 is a schematic, sectional, end view of an example of the system, depicting the compression housing in a closed state and a compacted stringer package;

FIG. 6 is a schematic, sectional side view of an example of the system, depicting an example of the compression housing in the open state and an example of the composite stringer package;

FIG. 7 is a schematic, sectional, end view of an example of the system, depicting an example of the compression housing in the closed state and an example of the composite stringer package;

FIG. 8 is a schematic, sectional, end view of an example of the system, depicting an example of the compression housing in the open state and an example of the compacted stringer package;

FIG. 9 is a schematic, sectional, end view of an example of the system, depicting an example of the compression housing in the open state and an example of the composite stringer package;

FIG. 10 is a schematic, sectional, end view of an example of the system, depicting an example of the compression housing in the open state and an example of the composite stringer package;

FIG. 11 is a schematic, block diagram of a composite manufacturing environment;

FIG. 12 is a flow diagram of an example of a composite manufacturing method;

FIG. 13 is a flow diagram of an example of a method for constructing a compacted stringer package;

FIG. 14 is a flow diagram of an example of an aircraft manufacturing and service method; and

FIG. 15 is a schematic block diagram of an example of an aircraft.

### DETAILED DESCRIPTION

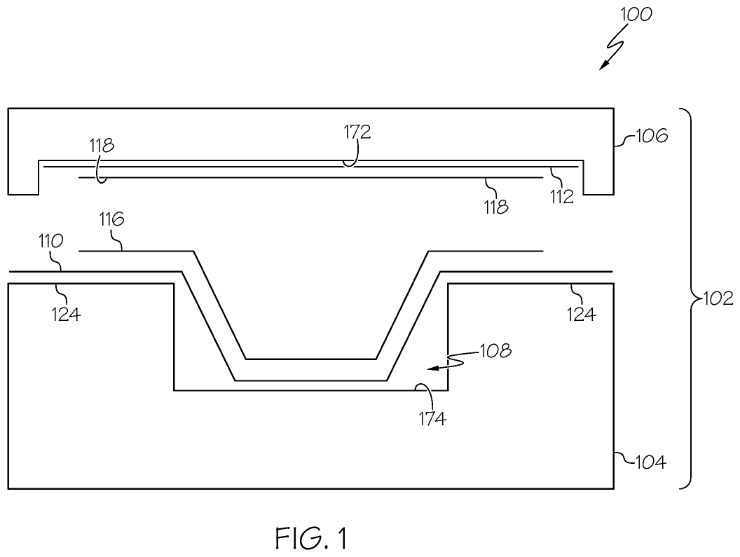

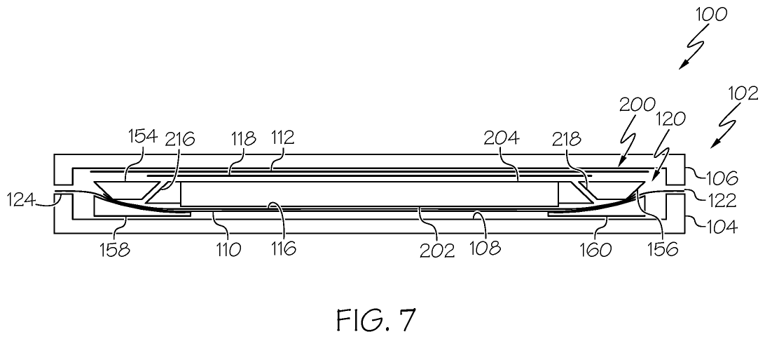

Referring generally to FIGS. 1-11, by way of examples, the present disclosure is directed to a system 100 for constructing a compacted stringer package 200. As will be described in more detail herein, the system 100 enables kitting all components needed for a composite stringer package 222 in a composite manufacturing environment 164, including a bladder, plies of composite material, and radius fillers. The system 100 also enables the composite stringer package 222 to be compacted to form the compacted stringer package 200. The system 100 further enables the compacted stringer package 200 to be stored and transported. The system 100 additionally enables single installation of an entirety of the compacted stringer package 200 onto a cure tool.

It can be appreciated that the components of the system 100 and the composite stringer package 222 are schematically illustrated by examples in FIGS. 1-10. As such, the different components of the system 100 and/or the composite stringer package 222 may be illustrated in a spaced-apart manner for the purpose of illustration clarity.

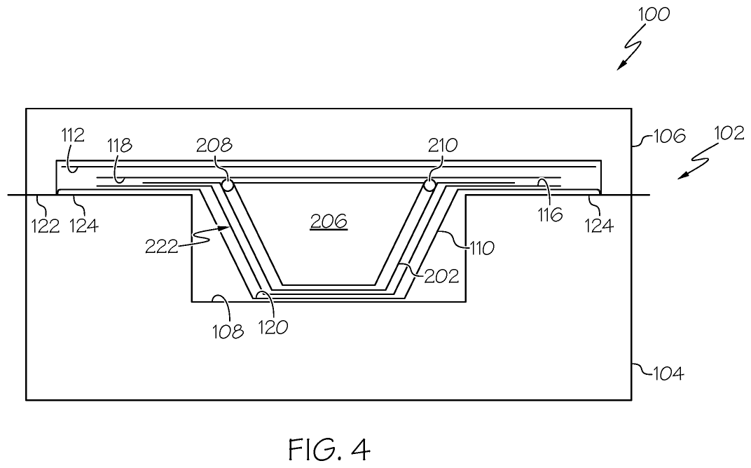

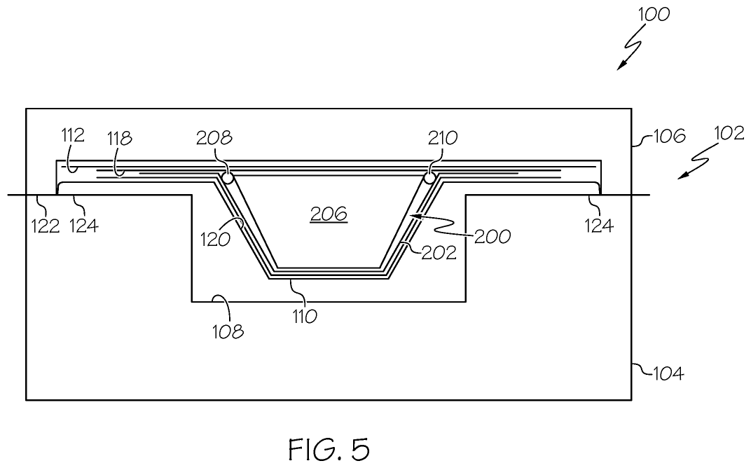

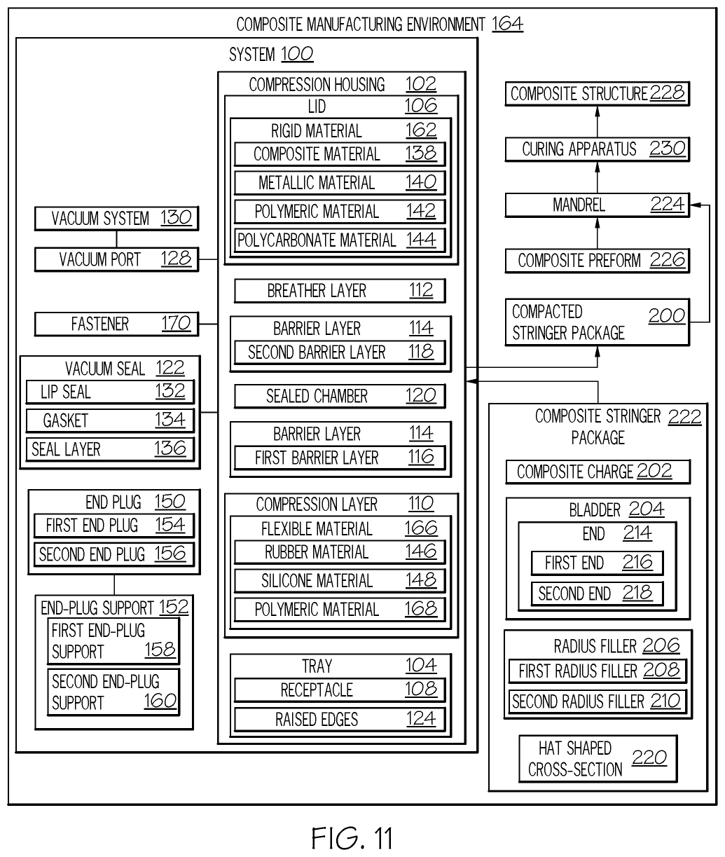

Referring to FIGS. 1 and 11, in one or more examples, the system 100 includes a compression housing 102. The compression housing 102 includes a tray 104. The compression housing 102 includes a lid 106. The lid 106 is movable relative to the tray 104 such that the compression housing 102 is in an open state (e.g., FIGS. 1-3) or in a closed state (e.g., FIGS. 4 and 5).

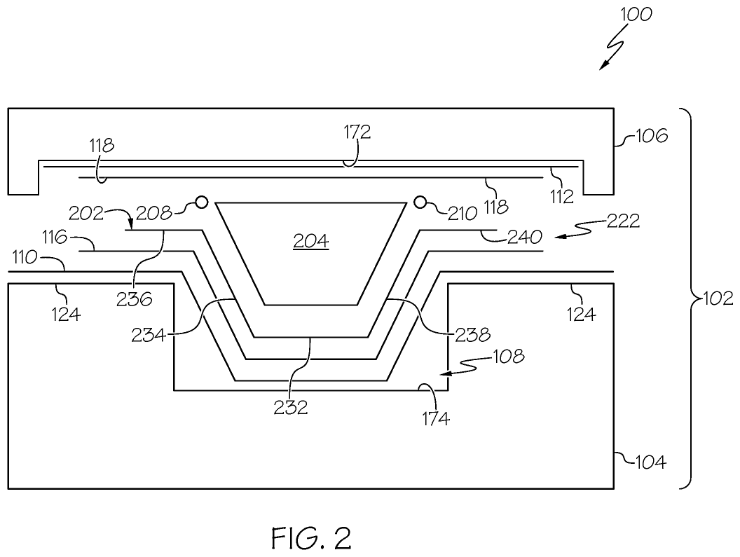

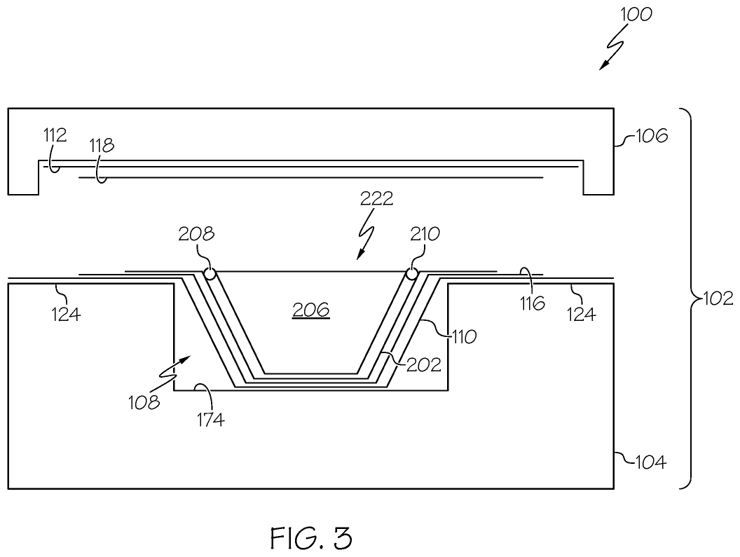

The tray 104 forms a base structure that supports the components of the composite stringer package 222 during arrangement of the components and construction of the composite stringer package 222 (e.g., as shown in FIGS. 2 and 3). The lid 106 enables closure of the compression housing 102 such that the tray 104 and the lid 106 form a sealed interior chamber (e.g., sealed chamber 120) that holds the composite stringer package 222 and that can be pressurized by application of vacuum to compact the composite stringer package 222. In one or more examples, the lid 106 also serves as a forming tool upon which the composite stringer package 222 is compacted.

Referring to FIG. 11, in one or more examples, the tray 104 and/or the lid 106 are rigid. As an example, the tray 104 and/or the lid 106 includes or is formed of a rigid material 162. In one or more examples, the tray 104 and/or the lid 106 includes or is formed of a composite material 138. In one or more examples, the tray 104 and/or the lid 106 includes or is formed of a metallic material 140. In one or more examples, the tray 104 and/or the lid 106 includes or is formed of a polymeric material 142. In one or more examples, the tray 104 and/or the lid 106 includes or is formed of a polycarbonate material 144.

In one or more examples, the compression housing 102 in held the closed state during a compaction operation by vacuum pressure within the compression housing 102. As an example, with the compression housing 102 in the closed state, the lid 106 is held against the tray 104 by vacuum pressure within a sealed chamber 120 formed by the tray 104 and the lid 106.

In one or more examples, the compression housing 102 is held in the closed state during a compaction operation by at least one fastener 170. As an example, with the compression housing 102 in the closed state, the lid 106 is secured or otherwise coupled to the tray 104 the at least one fastener 170 that is coupled to both the tray 104 and the lid 106. Examples of the fastener 170 include, but are not limited to, clamps, latches, clasps, nuts and bolts, and any other suitable type of mechanical fastener. Use of the fastener 170 may be advantageous to hold the tray 104 and the lid 106 together during periods where there is no active vacuum pressure being applied between the tray 104 and the lid 106.

Referring to FIGS. 1 and 11, in one or more examples, the system 100, or the compression housing 102, includes a compression layer 110. The compression layer 110 is positioned over the tray 104. In one or more examples, with the compression housing 102 in the closed state, the compression layer 110 and the lid 106 form the sealed chamber 120. With the compression housing 102 in the closed state and during application of vacuum within the sealed chamber 120, the compression layer 110 is drawn toward a forming surface 172 (FIG. 1) of the lid 106. In response to the vacuum, the compression layer 110 applies a compaction force to the composite stringer package 222 during the compaction process.

In one or more examples, the compression layer 110 is made of a material that is suitable for contact with green composite materials of the components that form the composite stringer package 222. In other examples, the system 100, or the compression housing 102, includes at least one barrier layer 114 (e.g., a first barrier layer 116 in FIG. 1) that is located against the compression layer 110, opposite the tray 104. In these examples, barrier layer 114 is made of a material that is suitable for contact with green composite materials of the components that form the composite stringer package 222.

Referring to FIG. 11, in one or more examples, the compression layer 110 is flexible. As an example, the compression layer 110 includes or is formed of a flexible material 166. In one or more examples, the compression layer 110 includes or is formed of a rubber material 146. In one or more examples, the compression layer 110 includes or is formed of a polymeric material 168. In one or more examples, the compression layer 110 includes or is formed of a silicone material 148. In one or more examples, the compression layer 110 includes or is formed of synthetic rubber sheet, a silicone rubber sheet, a fluoroelastomer (e.g., Viton™) rubber sheet, and the like, such as commercially available from Mosites Rubber Company, Inc. of Texas, USA.

Referring to FIGS. 1 and 11, in one or more examples, the system 100, or the compression housing 102, includes a breather layer 112. The breather layer 112 is positioned over or against the compression layer 110, opposite the tray 104. With the compression housing 102 in the closed state, the breather layer 112 distributes vacuum within the sealed chamber 120.

In one or more examples, the breather layer 112 is made of a material that is suitable for contact with green composite materials of the components that form the composite stringer package 222. In other examples, the system 100, or the compression housing 102, includes at least one barrier layer 114 (e.g., a second barrier layer 118 in FIG. 1) that is located against the breather layer 112, opposite the lid 106. In these examples, barrier layer 114 is made of a material that is suitable for contact with green composite materials of the components that form the composite stringer package 222.

In one or more examples, the breather layer 112 is flexible. The breather layer 112 is made of a material that is permeable to air. In one or more examples, the breather layer 112 includes a mesh breather. In one or more examples, the breather layer 112 includes or is made of one or more layer of a bi-planar mesh material.

Referring to FIGS. 4, 5 and 11, in one or more examples, with the compression housing 102 in the closed state, the breather layer 112 is positioned between the lid 106 and the compression layer 110. At least a portion of the breather layer 112 is located within the sealed chamber 120. In one or more examples, the breather layer 112 is coupled to the lid 106, such as to at least a portion of the forming surface 172 (FIG. 1) of the lid 106.

Referring to FIGS. 2, 3 and 11, in one or more examples, with the compression housing 102 in the open state, the tray 104 receives a portion of the composite stringer package 222. In one or more examples, the compression layer 110 is located on or is disposed over at least a portion of a support surface 174 (FIG. 1) of the tray 104. The first barrier layer 116 is located on or is disposed over at least a portion of the compression layer 110, opposite the tray 104.

Generally, the tray 104 includes a support surface 174 (FIG. 1) upon which the components of the composite stringer package 222 are placed and supported during construction. The tray 104 and, more particularly, the support surface 174 has a geometry suitable for the desired geometry and/or shape of the stringer being constructed using the system 100. In one or more examples, the stringer is intended to have a hat-shaped cross-section. As such, the tray 104 is configured to support the composite stringer package 222 such that the composite stringer package 222 has a hat-shaped cross-section 220 (FIG. 11). Generally, a composite stringer having the hat-shaped cross-section 220 includes a cap 232, a first web 234 that extends from the cap 232, a first flange 236 that extends from the first web 234 opposite the cap 232, a second web 238 that extends from the cap 232 opposite the first web 234, and a second flange 240 that extends from the second web 238 opposite the cap 232 (FIG. 2).

Referring to FIGS. 1-5 and 11, in one or more examples, the tray 104 includes or forms a receptacle 108. The tray 104 includes raised edges 124 that surround or define a perimeter of the receptacle 108. In these examples, the support surface 174 is formed by a floor and walls of the receptacle 108 and shoulders of the raised edges 124. In these example, the support surface 174 has a geometry that supports the hat-shaped cross-section 220 of the composite stringer package 222 being constructed on the tray 104.

In one or more examples, the compression layer 110 lines the support surface 174. As an example, a first portion of the compression layer 110 lines the receptacle 108. A second portion of the compression layer 110 extends over the raised edges 124. In one or more examples, with the compression housing 102 in the closed state (e.g., FIGS. 4 and 5), the second portion of the compression layer 110 is compressed between the raised edges 124 and the lid 106.

As illustrated in FIGS. 2 and 3, during construction of the composite stringer package 222, the components of the composite stringer package 222 are placed and arranged on the tray 104. In one or more examples, a composite charge 202 (e.g., one or more plies of composite material) is placed on the tray 104. In an example, the composite charge 202 is placed on or is disposed over a portion of the compression layer 110. In another example, composite charge 202 is placed on or is disposed over at least a portion of the first barrier layer 116.

In the illustrated examples, the composite charge 202 has the hat-shaped cross-section 220 (FIG. 1). In these examples, a bladder 204 is placed on or is disposed over the composite charge 202. In one or more examples, the composite charge 202 is placed (e.g., shaped or wrapped) around at least a portion of the bladder 204 to support further the hat-shaped cross-section 220. A first radius filler 208 is placed in contact with the composite charge 202 and the bladder 204. A second radius filler 210 is placed in contact with the composite charge 202 and the bladder 204. Generally, the first radius filler 208 and the second radius filler 210 extend the length of the composite stringer package 222 and are spaced apart from and aligned with each other.

As illustrated in FIGS. 4 and 5, in one or more examples, with the compression housing 102 in the closed state, the composite stringer package 222 is positioned within the sealed chamber 120 and the compression layer 110 compacts the composite stringer package 222 against the lid 106 in response to application of vacuum within the sealed chamber 120. In one or more examples, with the compression housing 102 in the closed state, the lid 106 is in contact with the compression layer 110 and a vacuum seal 122 is formed between the lid 106 and the compression layer 110.

Referring to FIGS. 1-5 and 11, in one or more examples, the at least one barrier layer 114 includes the first barrier layer 116 and the second barrier layer 118. With the compression housing 102 in the closed state (e.g., FIGS. 4 and 5), the first barrier layer 116 and/or the second barrier layer 118 are positioned between the compression layer 110 and the breather layer 112. As an example, with the compression housing 102 in the closed state, the first barrier layer 116 is positioned between the compression layer 110 and the composite charge 202 of the composite stringer package 222. With the compression housing 102 in the closed state, the second barrier layer 118 is positioned between the breather layer 112 and the composite charge 202, the bladder 204, the first radius filler 208, and the second radius filler 210 of the composite stringer package 222.

Referring to FIG. 11, in one or more examples, the system 100, or the compression housing 102, includes a vacuum port 128. In one or more examples, the vacuum port 128 is located on or is associated with the lid 106. The vacuum port 128 is in fluid communication with the internal chamber formed between the tray 104 and the lid 106. As an example, with the compression housing 102 in the closed state, the vacuum port 128 is in fluid communication with the sealed chamber 120. With the compression housing 102 in the closed state, vacuum is applied to the sealed chamber 120 through the breather layer 112 via the vacuum port 128.

Referring to FIG. 11, in one or more examples, the system 100 includes a vacuum system 130. The vacuum system 130 is coupled to the vacuum port 128. The vacuum system 130 generates vacuum and supplies vacuum to the compression housing 102. As an example, the vacuum system 130 includes a vacuum source (e.g., a pump) that is coupled to the vacuum port 128, such as via suitable vacuum lines. With the compression housing 102 in the closed state, the vacuum system 130 is selectively controlled to apply vacuum within the sealed chamber 120.

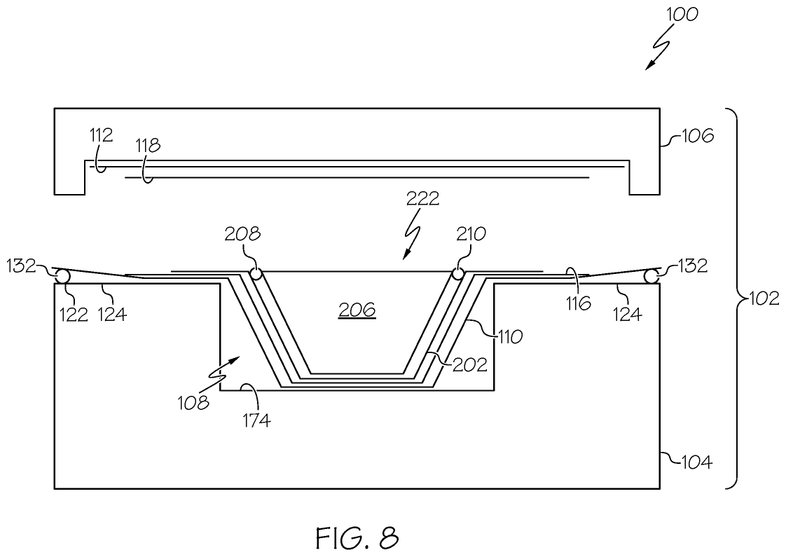

Referring to FIGS. 8 and 11, in one or more examples, the system 100, or the compression housing 102, includes a lip seal 132. The lip seal 132 is positioned between the tray 104 and the compression layer 110. In one or more examples, the lip seal 132 raises the compression layer 110 away from the tray 104 and toward the lid 106 and promotes a more effective instance of the vacuum seal 122 between the lid 106 and the compression layer 110.

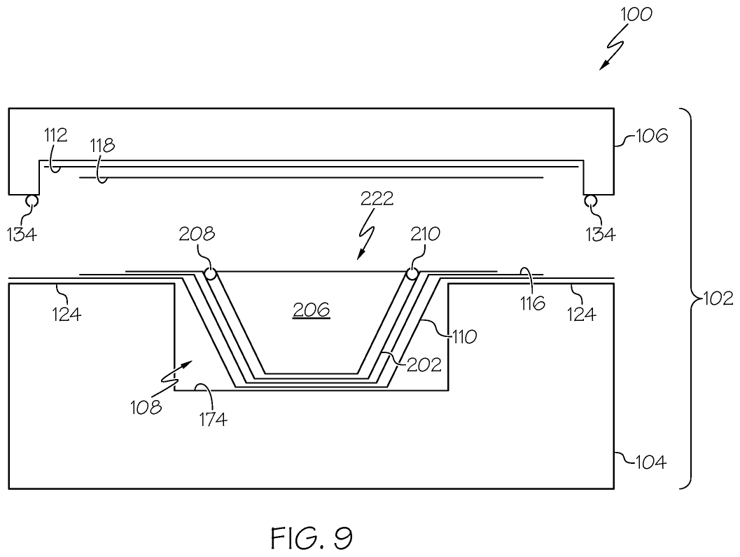

Referring to FIGS. 9 and 11, in one or more examples, the system 100, or the compression housing 102, includes a gasket 134. The gasket 134 is coupled to the lid 106. With the compression housing 102 in the closed state, the gasket 134 is in contact with the compression layer 110. In these examples, with the compression housing 102 in the closed state and the gasket 134 in contact with the compression layer 110, the vacuum seal 122 is formed between the gasket 134 and the compression layer 110.

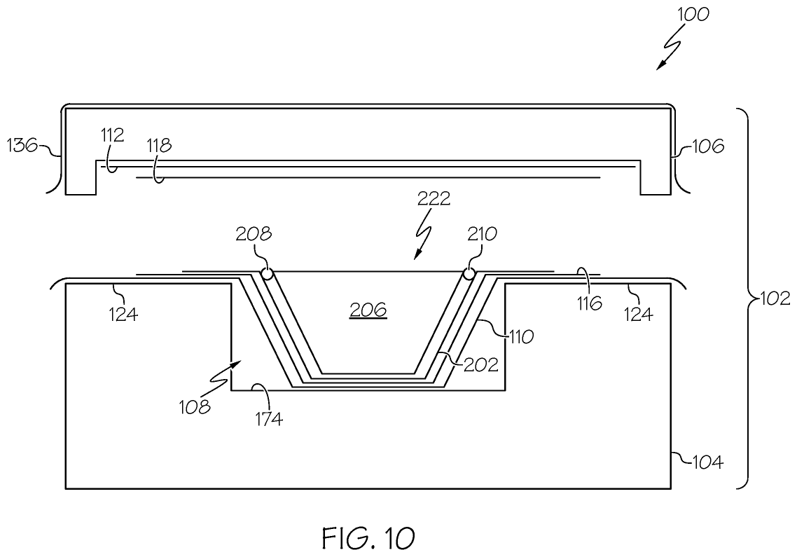

Referring to FIGS. 10 and 11, in one or more examples, the system 100, or the compression housing 102, includes a seal layer 136. The seal layer 136 is positioned over the lid 106. With the compression housing 102 in the closed state, a portion of the seal layer 136 is in contact with a portion of the compression layer 110. With the compression housing 102 in the closed state and the seal layer 136 in contact with the compression layer 110, the vacuum seal 122 is formed between the seal layer 136 and the compression layer 110. In one or more examples, the compression layer 110 and the seal layer 136 include or are made of the same material, thereby facilitating natural adhesion between the layers upon contact.

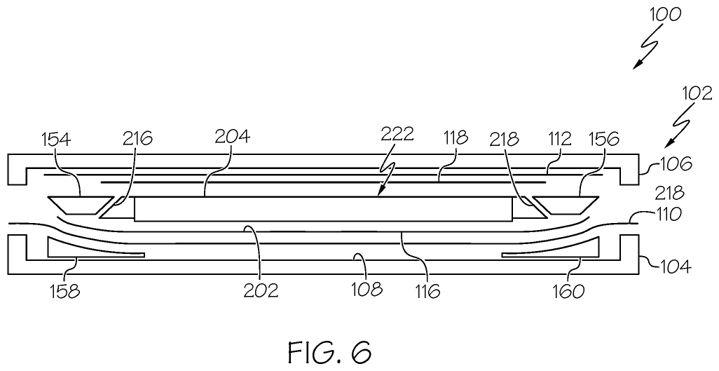

Referring to FIGS. 6, 7 and 11, in one or more examples, the system 100 includes at least one end plug 150. The at least one end plug 150 is positioned on the tray 104. In one or more examples, the at least one end plug 150 includes a first end plug 154. In one or more examples, the at least one end plug 150 includes a second end plug 156. As an example, the first end plug 154 is positioned proximate to or is coupled to a first end 216 of the bladder 204. The second end plug 156 is positioned proximate to or is coupled to a second end 218 of the bladder 204. With the compression housing 102 in the closed state, the at least one end plug 150 (e.g., the first end plug 154 and/or the second end plug 156) is positioned between the compression layer 110 and the breather layer 112. The end plug 150 provides a surface contour that encourages the compression layer 110 to tightly conform to the shape and/or contour of the composite stringer package 222 during compaction. Tightly conforming the compression layer 110 to the composite stringer package 222 reduces or prevents wrinkling and provides better compaction.

Referring to FIGS. 6, 7 and 11, in one or more examples, the system 100 includes at least one end-plug support 152. The at least one end-plug support 152 is positioned between the tray 104 and the compression layer 110. In one or more examples, the at least one end-plug support 152 includes a first end-plug support 158. In one or more examples, the at least one end-plug support 152 includes a second end-plug support 160. As an example, the first end-plug support 158 is positioned proximate to the first end 216 of the bladder 204. The second end plug 156 is positioned proximate to the second end 218 of the bladder 204. With the compression housing 102 in the closed state, the at least one end-plug support 152 (e.g., the first end-plug support 158 and/or the second end-plug support 160) receives a portion of the at least one end plug 150. The end-plug support 152 supports and holds the end plug 150 in position.

Referring generally to FIGS. 1-10 and particularly to FIG. 11, by way of examples, the present disclosure is also directed to the compacted stringer package 200.

Referring to FIGS. 2-5 and 11, in one or more examples, the compacted stringer package 200 includes the composite charge 202. In one or more examples, the compacted stringer package 200 includes the hat-shaped cross-section 220. In these examples, the composite charge 202 is placed over a portion of the bladder 204. The composite charge 202 is positioned on the tray 104 of the compression housing 102. The compacted stringer package 200 includes the first radius filler 208. The first radius filler 208 is positioned in contact with the composite charge 202 and the bladder 204. The compacted stringer package 200 includes the second radius filler 210. The second radius filler 210 is positioned in contact with the composite charge 202 and the bladder 204. The second radius filler 210 is spaced away from and is aligned with the first radius filler 208.

The composite charge 202, the bladder 204, the first radius filler 208, and the second radius filler 210 are enclosed within the sealed chamber 120 that is formed by the lid 106 of the compression housing 102 and the compression layer 110 that is positioned between the composite charge 202 and the tray 104. The composite charge 202, the bladder 204, the first radius filler 208, and the second radius filler 210 are compacted between the compression layer 110 and the lid 106 by vacuum applied within the sealed chamber 120. In one or more examples, vacuum is distributed to the sealed chamber 120 by the breather layer 112 that is positioned between the lid 106 and the compacted stringer package 200.

Referring to FIGS. 6, 7 and 11, in one or more examples, the at least one end plug 150 is positioned proximate at least one end 214 of the bladder 204 within the sealed chamber 120. In one or more examples, the first end plug 154 is positioned proximate the first end 216 of the bladder 204. In one or more examples, the second end plug 156 is positioned proximate the second end 218 of the bladder 204. The first end 216 and the second end 218 of the bladder 204 are opposite each other along a longitudinal axis of the bladder 204.

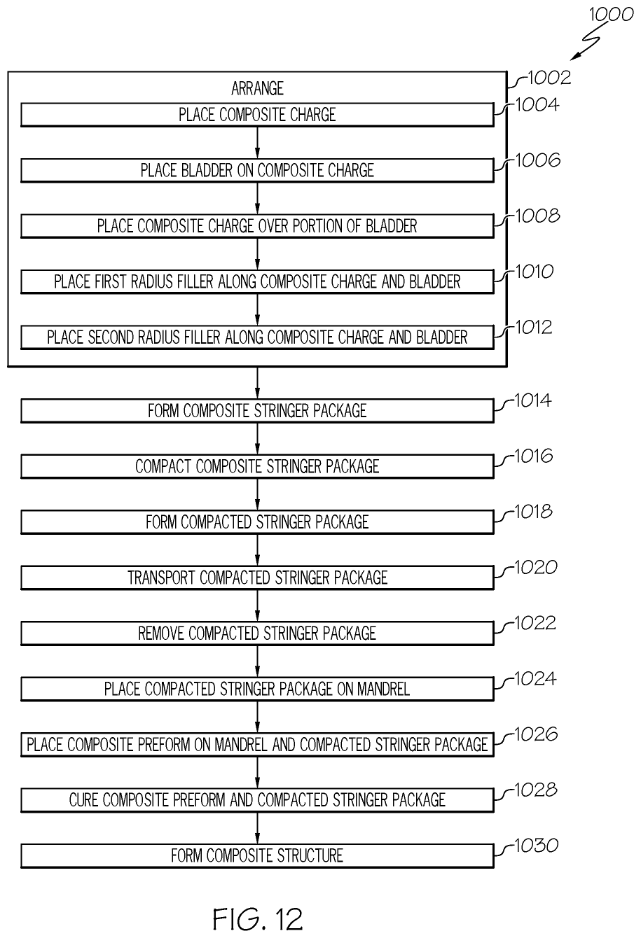

Referring generally to FIGS. 1-11 and particularly to FIG. 12, by way of examples, the present disclosure is also directed to a composite manufacturing method 1000. As will be described in more detail herein, the composite manufacturing method 1000 enables the composite stringer package 222 to be compacted to form the compacted stringer package 200. The method 1000 also enables the compacted stringer package 200 to be stored and transported. The method 1000 further enables single installation of an entirety of the compacted stringer package 200 onto a cure tool. The method 1000 additionally enables installation of a composite preform 226 onto the cure tool and over the compacted stringer package 200. The method 1000 also enables curing of the composite preform 226 and the compacted stringer package 200 on the cure tool to form a composite structure 228, such as a barrel section of an aircraft fuselage or an aircraft wing. In one or more examples, the method 1000 is performed using the system 100 (FIGS. 1-11).

Referring to FIG. 12, in one or more examples, the composite manufacturing method 1000 includes a step of (block 1002) arranging the composite charge 202, the bladder 204, and at least one radius filler 206 within the compression housing 102 to form the composite stringer package 222.

In one or more examples, step of (block 1002) arranging includes a step of (block 1004) placing the composite charge 202, a step of (block 1006) placing the bladder 204 on the composite charge 202; a step of (block 1008) placing the composite charge 202 over a portion of a bladder 204, a step of (block 1010) placing the first radius filler 208, and a step of (block 1012) placing the second radius filler 210.

In one or more examples, the composite manufacturing method 1000 includes a step of (block 1014) forming the composite stringer package 222. In one or more examples, the composite stringer package 222 is formed by the arrangement of the composite charge 202, the bladder 204, the first radius filler 208, and the second radius filler 210.

In one or more examples, the composite manufacturing method 1000 includes a step of (block 1016) compacting the composite stringer package 222. The composite stringer package 222 is compacted within the compression housing 102. Compacting the composite stringer package 222 forms the compacted stringer package 200. In one or more examples, the composite manufacturing method 1000 includes a step of (block 1018) forming the compacted stringer package 200.

In one or more examples, the composite manufacturing method 1000 includes a step of (block 1020) transporting the compacted stringer package 200 to a mandrel 224. In one or more examples, the mandrel 224 is a cure tool for fabrication of the composite structure 228.

In one or more examples, the composite manufacturing method 1000 includes a step of (block 1022) removing the compacted stringer package 200.

In one or more examples, the composite manufacturing method 1000 includes a step of (block 1024) placing the compacted stringer package 200 on the mandrel 224.

In one or more examples, the composite manufacturing method 1000 includes a step of (block 1026) placing the composite preform 226 on the mandrel 224 over the compacted stringer package 200.

In one or more examples, the composite manufacturing method 1000 includes a step of (block 1028) co-curing the composite preform 226 and the compacted stringer package 200 on the mandrel 224. In one or more examples, the composite preform 226 and the compacted stringer package 200 are cured on the mandrel 224 using a curing apparatus 230, such as an oven or an autoclave.

In one or more examples, the composite manufacturing method 1000 includes a step of (block 1030) forming the composite structure 228.

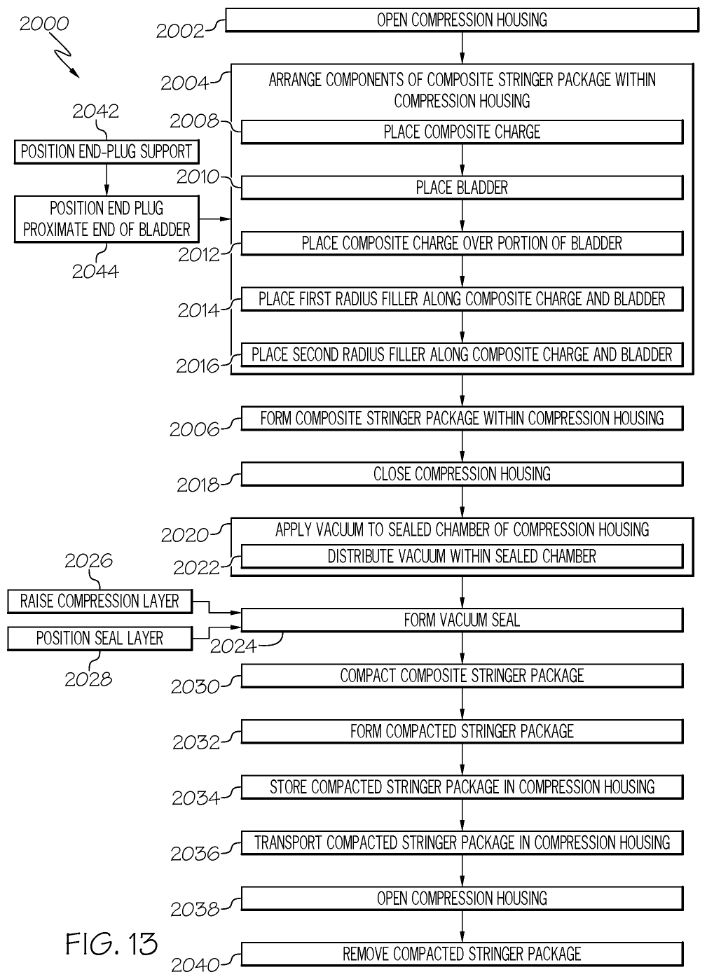

Referring generally to FIGS. 1-11 and particularly to FIG. 13, by way of examples, the present disclosure is also directed to a method 2000 for constructing the compacted stringer packager 200. As will be described in more detail herein, the method 2000 enables kitting all components needed for the composite stringer package 222, including a bladder, plies of composite material, and radius fillers. The method 2000 also enables the composite stringer package 222 to be compacted to form the compacted stringer package 200. The method 2000 further enables the compacted stringer package 200 to be stored and transported. The method 2000 additionally enables single installation of an entirety of the compacted stringer package 200 onto a cure tool. In one or more examples, the method 2000 is an implementation of or forms a portion of the composite manufacturing method 1000 (FIG. 12). In one or more examples, the method 2000 is performed using the system 100 (FIGS. 1-11).

In one or more examples, the method 2000 includes a step of (block 2002) opening the compression housing 102 of the system 100. The method 2000 includes a step of (block 2004) arranging the components of the composite stringer package 222, including the composite charge 202. the bladder 204, and at least one radius filler 206, on the tray 104 of the compression housing 102 to form the composite stringer package 222. As an example, the method 2000 includes a step of (block 2006) forming the composite stringer package 222. The step of (block 2004) arranging and the step of (block 2006) forming are performed with the compression housing 102 in the open state. In one or more examples, the composite stringer package 222 includes the hat-shaped cross-section 220.

In one or more examples, the step of (block 2004) arranging the components to form the composite stringer package 222 includes a step of (block 2008) placing the composite charge 202 on the tray 104 of the compression housing 102. The composite charge 202 is placed on or over the compression layer 110. The compression layer 110 is positioned over the tray 104 such that the compression layer 110 is positioned between the composite charge 202 and the tray 104 after the step of (block 2008) placing the composite charge 202.

In one or more examples, the step of (block 2004) arranging the components to form the composite stringer package 222 includes a step of (block 2010) placing the bladder 204 on the tray 104. In one or more examples, the bladder 204 is placed on the tray 104 such that the composite charge 202 is placed over a portion of the bladder 204. As an example, the step of (block 2004) arranging includes a step of (block 2012) placing the composite charge 202 over a portion of the bladder 204.

In one or more examples, the step of (block 2004) arranging the components to form the composite stringer package 222 includes a step of (block 2014) placing the first radius filler 208 along the composite charge 202 and the bladder 204 and a step of (block 2016) placing the second radius filler 210 along the composite charge 202 and the bladder 204.

In one or more examples, the method 2000 includes a step of (block 2018) closing the compression housing 102. As an example, the method 2000 includes a step of positioning the lid 106 relative to the tray 104 such that the compression housing 102 is in the closed state.

In one or more examples, method 2000 includes a step of (block 2020) applying vacuum to the sealed chamber 120 that is formed by the lid 106 and the compression layer 110. The compression layer 110 is positioned between the composite charge 202 and the tray 104. The composite stringer package 222 is positioned between the lid 106 and the compression layer 110 and is sealed within the sealed chamber 120. The step of (block 2020) applying vacuum to the sealed chamber 120 is performed with the compression housing 102 in the closed state.

In one or more examples, the step of (block 2020) applying vacuum includes a step of (block 2022) distributing vacuum within the sealed chamber 120 using the breather layer 112 that is positioned between the lid 106 and the composite stringer package 222 and that is positioned within the sealed chamber 120.

In one or more examples, the method 2000 includes a step of (block 2024) forming the vacuum seal 122. The step of (block 2024) forming the vacuum seal 122 is performed with the compression housing 102 in the closed state. In one or more examples, the vacuum seal 122 is formed between the lid 106 and the compression layer 110. In one or more examples, the vacuum seal 122 is formed between the gasket 134 that is coupled to the lid 106 and the compression layer 110.

In one or more examples, the method 2000 includes a step of (block 2026) raising the compression layer 110 relative to the tray 104 using the lip seal 132. The lip seal 132 is positioned between the tray 104 and the compression layer 110. Raising the compression layer 110 relative to the tray 104 and toward the lid 106 improves the vacuum seal 122 formed between the lid 106 and the compression layer 110.

In one or more examples, the method 2000 includes a step of (block 2028) positioning the seal layer 136 over the lid 106. In these examples, the vacuum seal 122 is formed between the seal layer 136 and the compression layer 110. In one or more examples, the step of (block 2028) positioning the seal layer 136 over the lid 106 is performed with the compression housing 102 in the closed state.

In one or more examples, the method 2000 includes a step of (block 2030) compacting, by applying vacuum, the composite stringer package 222 between the compression layer 110 and the lid 106. Compacting, by applying vacuum, the composite stringer package 222 between the compression layer 110 and the lid 106 forms the compacted stringer package 200. As an example, the method 2000 includes a step of (block 2032) forming the compacted stringer package 200. In one or more examples, the compacted stringer package 200 includes the hat-shaped cross-section 220.

In one or more examples, the method 2000 includes a step of (block 2034) storing the compacted stringer package 200 within the compression housing 102. In one or more examples, the compacted stringer package 200 can be stored in the compression housing 102 under vacuum pressure. In one or more examples, the compacted stringer package 200 can be stored in the compression housing 102 without application of vacuum.

In one or more examples, the method 2000 includes a step of (block 2036) transporting the compacted stringer package 200 within the compression housing 102. In one or more examples, the compacted stringer package 200 can be transported in the compression housing 102 under vacuum pressure. In one or more examples, the compacted stringer package 200 can be transported in the compression housing 102 without application of vacuum.

In one or more examples, the method 2000 includes a step of (block 2038) opening the compression housing 102. As an example, the method 2000 includes a step of positioning (e.g., repositioning) the lid 106 relative to the tray 104 such that the compression housing 102 is in the open state. In one or more examples, the method 2000 includes a step of (block 2040) removing the compacted stringer package 200. As an example, compacted stringer package 200 is removed from the tray 104 after the lid 106 has been repositioned away from the tray 104.

In one or more examples, the method 2000 includes a step of (block 2042) positioning at least one end plug 150 proximate at least one end 214 of the bladder 204. With the compression housing 102 in the closed state, the at least one end plug 150 is positioned within the sealed chamber 120. In one or more examples, the method 2000 includes a step of positioning the first end plug 154 proximate the first end 216 of the bladder 204. In one or more examples, the method 2000 includes a step of positioning the second end plug 156 proximate the second end 218 of the bladder 204.

In one or more examples, the method 2000 includes a step of (block 2044) positioning at least one end-plug support 152 between the tray 104 and the compression layer 110. With the compression housing 102 in the closed state, the at least one end-plug support 152 receives a portion of the at least one end plug 150. In one or more examples, the method 2000 includes a step of positioning the first end-plug support 158 between the tray 104 and the compression layer 110. The first end-plug support 158 receives a portion of the first end plug 154. In one or more examples, the method 2000 includes a step of positioning the second end-plug support 160 between the tray 104 and the compression layer 110. The second end-plug support 160 receives a portion of the second end plug 156.

Referring to FIG. 11, for the purpose of the present disclosure, the composite structure 228 includes any suitable composite part, article, object, component, and the liked, such as an aerospace composite structure used to form a fuselage, wings, and other components of an aircraft. The composite structure 228 includes or refers to the cured composite part.

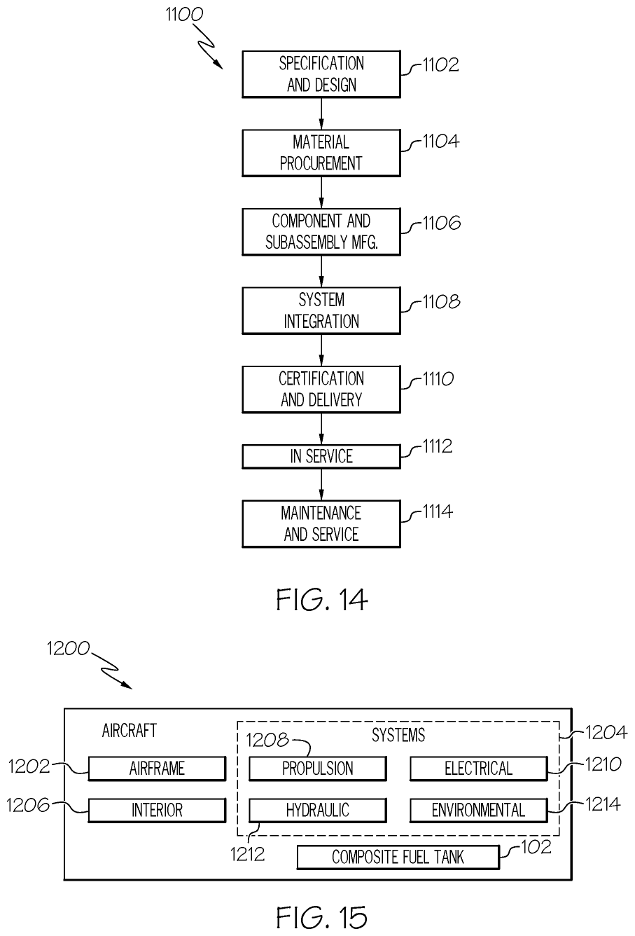

Referring now to FIGS. 14 and 15, examples of the system 100, the compression housing 102, the method 1000, the method 2000, and the compacted stringer package 200 described herein, may be related to, or used in the context of, an aircraft manufacturing and service method 1100, as shown in the flow diagram of FIG. 14 and an aircraft 1200, as schematically illustrated in FIG. 15. For example, the aircraft 1200 and/or the aircraft production and service method 1100 may include the composite structure 228 that includes a stringer that is constructed and compacted using the system 100 and/or the compression housing and/or according to the method 1000 or the method 2000.

Referring to FIG. 15, which illustrates an example of the aircraft 1200. The aircraft 1200 includes an airframe 1202 having an interior 1206. The aircraft 1200 includes a plurality of onboard systems 1204 (e.g., high-level systems). Examples of the onboard systems 1204 of the aircraft 1200 include propulsion systems 1208, hydraulic systems 1212, electrical systems 1210, and environmental systems 1214. In other examples, the onboard systems 1204 also includes one or more control systems coupled to an airframe 1202 of the aircraft 1200, such as for example, flaps, spoilers, ailerons, slats, rudders, elevators, and trim tabs. In yet other examples, the onboard systems 1204 also includes one or more other systems, such as, but not limited to, communications systems, avionics systems, software distribution systems, network communications systems, passenger information/entertainment systems, guidance systems, radar systems, weapons systems, and the like. The aircraft 1200 may include various composite structures (e.g., composite structure 228) that include stringer made using the system 100 and/or the compression housing 102 and/or according to the method 1000 or the method 2000.

Referring to FIG. 14, during pre-production of the aircraft 1200, the manufacturing and service method 1100 includes specification and design of the aircraft 1200 (block 1102) and material procurement (block 1104). During production of the aircraft 1200, component and subassembly manufacturing (block 1106) and system integration (block 1108) of the aircraft 1200 take place. Thereafter, the aircraft 1200 goes through certification and delivery (block 1110) to be placed in service (block 1112). Routine maintenance and service (block 1114) includes modification, reconfiguration, refurbishment, etc. of one or more systems of the aircraft 1200.

Each of the processes of the manufacturing and service method 1100 illustrated in FIG. 14 may be performed or carried out by a system integrator, a third party, and/or an operator (e.g., a customer). For the purposes of this description, a system integrator may include, without limitation, any number of spacecraft manufacturers and major-system subcontractors; a third party may include, without limitation, any number of vendors, subcontractors, and suppliers; and an operator may be an airline, leasing company, military entity, service organization, and so on.

Examples of the system 100, the compression housing 102, the method 1000, the method 2000, and the compacted stringer package 200 shown and described herein, may be employed during any one or more of the stages of the manufacturing and service method 1100 shown in the flow diagram illustrated by FIG. 14. In an example, constructing the compacted stringer package 200 using the system 100 and/or the compression housing 102 and/or according to the method 1000 or the method 2000 may form a portion of component and subassembly manufacturing (block 1106) and/or system integration (block 1108). Further, the compacted stringer package 200 formed using the system 100 and/or the compression housing 102 and/or according to the method 1000 or the method 2000 may be implemented in a manner similar to components or subassemblies prepared while the aircraft 1200 is in service (block 1112). Also, the compacted stringer package 200 formed using the system 100 and/or the compression housing 102 and/or according to the method 1000 or the method 2000 may be utilized during system integration (block 1108) and certification and delivery (block 1110). Similarly, the compacted stringer package 200 formed using the system 100 and/or the compression housing 102 and/or according to the method 1000 or the method 2000 may be utilized, for example and without limitation, while the aircraft 1200 is in service (block 1112) and during maintenance and service (block 1114).

The preceding detailed description refers to the accompanying drawings, which illustrate specific examples described by the present disclosure. Other examples having different structures and operations do not depart from the scope of the present disclosure. Like reference numerals may refer to the same feature, element, or component in the different drawings. Throughout the present disclosure, any one of a plurality of items may be referred to individually as the item and a plurality of items may be referred to collectively as the items and may be referred to with like reference numerals. Moreover, as used herein, a feature, element, component, or step preceded with the word “a” or “an” should be understood as not excluding a plurality of features, elements, components, or steps, unless such exclusion is explicitly recited.

Illustrative, non-exhaustive examples, which may be, but are not necessarily, claimed, of the subject matter according to the present disclosure are provided above. Reference herein to “example” means that one or more feature, structure, element, component, characteristic, and/or operational step described in connection with the example is included in at least one aspect, embodiment, and/or implementation of the subject matter according to the present disclosure. Thus, the phrases “an example,” “another example,” “one or more examples,” and similar language throughout the present disclosure may, but do not necessarily, refer to the same example. Further, the subject matter characterizing any one example may, but does not necessarily, include the subject matter characterizing any other example. Moreover, the subject matter characterizing any one example may be, but is not necessarily, combined with the subject matter characterizing any other example.

As used herein, a system, apparatus, device, structure, article, element, component, or hardware “configured to” perform a specified function is indeed capable of performing the specified function without any alteration, rather than merely having potential to perform the specified function after further modification. In other words, the system, apparatus, device, structure, article, element, component, or hardware “configured to” perform a specified function is specifically selected, created, implemented, utilized, programmed, and/or designed for the purpose of performing the specified function. As used herein, “configured to” denotes existing characteristics of a system, apparatus, structure, article, element, component, or hardware that enable the system, apparatus, structure, article, element, component, or hardware to perform the specified function without further modification. For purposes of this disclosure, a system, apparatus, device, structure, article, element, component, or hardware described as being “configured to” perform a particular function may additionally or alternatively be described as being “adapted to” and/or as being “operative to” perform that function.

Unless otherwise indicated, the terms “first,” “second,” “third,” etc. are used herein merely as labels, and are not intended to impose ordinal, positional, or hierarchical requirements on the items to which these terms refer. Moreover, reference to, e.g., a “second” item does not require or preclude the existence of, e.g., a “first” or lower-numbered item, and/or, e.g., a “third” or higher-numbered item.

As used herein, the phrase “at least one of”, when used with a list of items, means different combinations of one or more of the listed items may be used and only one of each item in the list may be needed. For example, “at least one of item A, item B, and item C” may include, without limitation, item A or item A and item B. This example also may include item A, item B, and item C, or item B and item C. In other examples, “at least one of” may be, for example, without limitation, two of item A, one of item B, and ten of item C; four of item B and seven of item C; and other suitable combinations. As used herein, the term “and/or” and the “/” symbol includes any and all combinations of one or more of the associated listed items.

For the purpose of this disclosure, the terms “coupled,” “coupling,” and similar terms refer to two or more elements that are joined, linked, fastened, attached, connected, put in communication, or otherwise associated (e.g., mechanically, electrically, fluidly, optically, electromagnetically) with one another. In various examples, the elements may be associated directly or indirectly. As an example, clement A may be directly associated with element B. As another example, clement A may be indirectly associated with element B, for example, via another element C. It will be understood that not all associations among the various disclosed elements are necessarily represented. Accordingly, couplings other than those depicted in the figures may also exist.

As used herein, the term “approximately” refers to or represents a condition that is close to, but not exactly, the stated condition that still performs the desired function or achieves the desired result. As an example, the term “approximately” refers to a condition that is within an acceptable predetermined tolerance or accuracy, such as to a condition that is within 10% of the stated condition. However, the term “approximately” does not exclude a condition that is exactly the stated condition. As used herein, the term “substantially” refers to a condition that is essentially the stated condition that performs the desired function or achieves the desired result.

FIGS. 1-11 and 15, referred to above, may represent functional elements, features, or components thereof and do not necessarily imply any particular structure. Accordingly, modifications, additions and/or omissions may be made to the illustrated structure. Additionally, those skilled in the art will appreciate that not all elements, features, and/or components described and illustrated in FIGS. 1-11 and 15, referred to above, need be included in every example and not all elements, features, and/or components described herein are necessarily depicted in each illustrative example. Accordingly, some of the elements, features, and/or components described and illustrated in FIGS. 1-11 and 15 may be combined in various ways without the need to include other features described and illustrated in FIGS. 1-11 and 15, other drawing figures, and/or the accompanying disclosure, even though such combination or combinations are not explicitly illustrated herein. Similarly, additional features not limited to the examples presented, may be combined with some or all of the features shown and described herein. Unless otherwise explicitly stated, the schematic illustrations of the examples depicted in FIGS. 1-11 and 15, referred to above, are not meant to imply structural limitations with respect to the illustrative example. Rather, although one illustrative structure is indicated, it is to be understood that the structure may be modified when appropriate. Accordingly, modifications, additions and/or omissions may be made to the illustrated structure. Furthermore, elements, features, and/or components that serve a similar, or at least substantially similar, purpose are labeled with like numbers in each of FIGS. 1-11 and 15, and such elements, features, and/or components may not be discussed in detail herein with reference to each of FIGS. 1-11 and 15. Similarly, all elements, features, and/or components may not be labeled in each of FIGS. 1-11 and 15, but reference numerals associated therewith may be utilized herein for consistency.

In FIGS. 12-14, referred to above, the blocks may represent operations, steps, and/or portions thereof and lines connecting the various blocks do not imply any particular order or dependency of the operations or portions thereof. It will be understood that not all dependencies among the various disclosed operations are necessarily represented. FIGS. 12-14 and the accompanying disclosure describing the operations of the disclosed methods set forth herein should not be interpreted as necessarily determining a sequence in which the operations are to be performed. Rather, although one illustrative order is indicated, it is to be understood that the sequence of the operations may be modified when appropriate. Accordingly, modifications, additions and/or omissions may be made to the operations illustrated and certain operations may be performed in a different order or simultaneously. Additionally, those skilled in the art will appreciate that not all operations described need be performed.

Further, references throughout the present specification to features, advantages, or similar language used herein do not imply that all of the features and advantages that may be realized with the examples disclosed herein should be, or are in, any single example. Rather, language referring to the features and advantages is understood to mean that a specific feature, advantage, or characteristic described in connection with an example is included in at least one example. Thus, discussion of features, advantages, and similar language used throughout the present disclosure may, but do not necessarily, refer to the same example.

The described features, advantages, and characteristics of one example may be combined in any suitable manner in one or more other examples. One skilled in the relevant art will recognize that the examples described herein may be practiced without one or more of the specific features or advantages of a particular example. In other instances, additional features and advantages may be recognized in certain examples that may not be present in all examples. Furthermore, although various examples of the system 100, the compression housing 102, the compacted stringer package 200, the method 1000 and the method 2000 have been shown and described, modifications may occur to those skilled in the art upon reading the specification. The present application includes such modifications and is limited only by the scope of the claims.

What is claimed is:

1. A system for constructing a compacted stringer package, the system comprising:
a compression housing comprising:
a tray; and
a lid that is movable relative to the tray such that the compression housing is in an open state or in a closed state;
a compression layer that is positioned over the tray; and
a breather layer that is positioned over the compression layer,
wherein, with the compression housing in the closed state:
the lid and the compression layer form a sealed chamber;
the breather layer is positioned between the lid and the compression layer and within the sealed chamber; and
the breather layer distributes vacuum within the sealed chamber.

2. The system of claim 1, wherein:
with the compression housing in the open state, the tray receives a portion of a composite stringer package; and
with the compression housing in the closed state, a composite stringer package is positioned within the sealed chamber and the compression layer compacts the composite stringer package against the lid in response to application of vacuum within the sealed chamber.

3. The system of claim 1, wherein:
the tray comprises:
a receptacle; and
raised edges that surround the receptacle;
a first portion of the compression layer lines the receptacle and second portion of the compression layer extends over the raised edges; and
with the compression housing in the closed state, the second portion of the compression layer is compressed between the raised edges and the lid.

4. The system of claim 1, wherein, with the compression housing in the closed state, the lid is in contact with the compression layer and a vacuum seal is formed between the lid and the compression layer.

5. The system of claim 1, further comprising at least one barrier layer,
wherein, with the compression housing in the closed state, the at least one barrier layer is positioned between the compression layer and the breather layer.

6. The system of claim 1, wherein the breather layer is coupled to the lid.

7. The system of claim 1, further comprising a vacuum port located on the lid,
wherein, with the compression housing in the closed state, vacuum is applied to the sealed chamber through the breather layer via the vacuum port.

8. The system of claim 7, further comprising a vacuum system that is coupled to the vacuum port,
wherein, with the compression housing in the closed state, the vacuum system is selectively controlled to apply vacuum within the sealed chamber.

9. The system of claim 1, further comprising a lip seal positioned between the tray and the compression layer.

10. The system of claim 1, further comprising a gasket that is coupled to the lid,
wherein, with the compression housing in the closed state, the gasket is in contact with the compression layer and a vacuum seal is formed between the gasket and the compression layer.

11. The system of claim 1, further comprising a seal layer positioned over the lid,
wherein, with the compression housing in the closed state, the seal layer is in contact with the compression layer and a vacuum seal is formed between the seal layer and the compression layer.

12. The system of claim 11, wherein the compression layer and the seal layer comprise the same material.

13. The system of claim 1, further comprising at least one end plug that is positioned on the tray,
wherein, with the compression housing in the closed state, the at least one end plug is positioned between the compression layer and the breather layer.

14. The system of claim 13, further comprising at least one end-plug support that is positioned between the tray and the compression layer,
wherein, with the compression housing in the closed state, the at least one end-plug support receives a portion of the at least one end plug.

15. The system of claim 1, wherein the lid is rigid and comprises at least one of a composite material, a metallic material, a polymeric material, and a polycarbonate material.

16. The system of claim 1, wherein the compression layer is flexible and comprises at least one of a rubber material, a polymeric material, and a silicone material.

17. A composite manufacturing method comprising steps of:
arranging a composite charge, a bladder, and at least one radius filler within a compression housing to form a composite stringer package; and
compacting the composite stringer package within the compression housing to form a compacted stringer package.

18. The method of claim 17, further comprising:
transporting the compacted stringer package within the compression housing to a mandrel;
removing the compacted stringer package form the compression housing;
placing the compacted stringer package on the mandrel; and
placing a composite preform on the mandrel over the compacted stringer package.

19. The method of claim 18, further comprising co-curing the composite preform and the compacted stringer package on the mandrel.

20. A compacted stringer package comprising:
a composite charge that is placed over a portion of a bladder and positioned on a tray of a compression housing;
a first radius filler that is positioned in contact with the composite charge and the bladder; and
a second radius filler that is positioned in contact with the composite charge and the bladder and aligned with the first radius filler,
wherein:
the composite charge, the bladder, the first radius filler, and the second radius filler are enclosed within a sealed chamber that is formed by a lid of the compression housing and a compression layer that is positioned between the composite charge and the tray; and
the composite charge, the bladder, the first radius filler, and the second radius filler are compacted between the compression layer and the lid by vacuum applied within the sealed chamber.
